(19) United States
(12) Patent Application Publication
(10) Pub. No.: US 2025/0042177 A1
(43) Pub. Date: Feb. 6, 2025

(54) PRINTING DEVICE INCLUDING HEATING ELEMENTS HEATING INK RIBBON SELECTIVELY USING FIRST ENERGY AND SECOND ENERGY

(71) Applicant: BROTHER KOGYO KABUSHIKI KAISHA, Nagoya (JP)

(72) Inventors: Satoru ITO, Nagoya (JP); Masaya FUJITA, Toyokawa (JP); Mina KATAOKA, Kyoto (JP); Haruki MATSUMOTO, Nagoya (JP); Yuki HOKARI, Nagoya (JP)

(21) Appl. No.: 18/926,887

(22) Filed: Oct. 25, 2024

Related U.S. Application Data
(63) Continuation of application No. PCT/JP2023/016246, filed on Apr. 25, 2023.

(30) Foreign Application Priority Data
Apr. 28, 2022 (JP) 2022-073977

(51) Int. Cl. B41J 2/355; B41J 2/325; B41J 33/14

(52) U.S. Cl. CPC B41J 2/3551; B41J 2/325; B41J 2/3558; B41J 33/14

(57) ABSTRACT

A printing device conveys an ink ribbon and a printing medium in a sub-scanning direction. In the ink ribbon, a base layer, a first ink layer, and a second ink layer are overlaid in this order. A processor of the printing device supplies a first energy to a first heating element to heat the ink ribbon and supplies a second energy to a second heating element to heat the ink ribbon. The second energy is different from the first energy. The first heating element is one of a plurality of heating elements in a thermal head. The second heating element is different from the first heating element. The processor transfers both the first ink and the second ink onto the printing medium from the ink ribbon by supplying the first energy. The processor transfers the second ink onto the printing medium from the ink ribbon by supplying the second energy.

### REFERENCE TO RELATED APPLICATIONS

This application is a by-pass continuation application of International Application No. PCT/JP2023/016246 filed Apr. 25, 2023 claiming priority from Japanese Patent Application No. 2022-073977 filed Apr. 28, 2022. The entire contents of the international application and the priority application are incorporated herein by reference.

### BACKGROUND ART

Thermal transfer printing devices capable of multicolor printing have been proposed. Japanese Patent Application Publication No. 2012-200874 discloses a thermal transfer color printer that prints on paper using a plurality of ink ribbons of different colors. This thermal transfer color printer has a plurality of thermal heads that have a one-on-one correspondence to the plurality of ink ribbons. The thermal heads heat the corresponding ink ribbons to transfer ink onto paper. Multicolor printing is performed by sequentially transferring ink in different colors onto the paper from the plurality of ink ribbons.

### SUMMARY

The thermal transfer color printer described above requires a plurality of ink ribbons and a plurality of thermal heads to achieve multicolor printing. This is problematic in that the configuration of the color printer is complex. Moreover, the printer body must be large to accommodate the plurality of ink ribbons and the plurality of thermal heads. Additionally, maintenance such as the replacement of ink ribbons and thermal heads is time-consuming.

An object of the present disclosure is to provide a printing device capable of performing multicolor printing and having a simplified configuration that enables the device to be more compact and easier to maintain, and a method of printing with the printing device.

In order to attain the above and other object the present disclosure provides a printing device according to first aspect. The printing device includes a first conveying member, a line thermal head, a transfer member, and a processor. The first conveying member is configured to convey an ink ribbon in a sub-scanning direction. The ink ribbon includes a base layer, a first ink layer having a first ink, and a second ink layer having a second ink different from the first ink. The base layer, the first ink layer, and the second ink layer are overlaid in this order. The second conveying member is configured to convey, in the sub-scanning direction, a printing medium that is overlaid on the ink ribbon and faces the second ink layer. The line thermal head has a plurality of heating elements arranged in a main scanning direction orthogonal to the sub-scanning direction. The plurality of heating elements is configured to be in contact with the ink ribbon from the base layer side to heat the ink ribbon while the ink ribbon is conveyed by the first conveying member. The transfer member is positioned downstream of the line thermal head in the sub-scanning direction. The transfer member is configured to transfer at least one of the first ink and the second ink from the ink ribbon heated by the line thermal head onto the printing medium, by separating the ink ribbon conveyed by the first conveying member from the printing medium. The processor is configured to control the first conveying member, the second conveying member, the line thermal head, and the transfer member. The processor is configured to perform: a first heating operation supplying a first energy to a first heating element to heat the ink ribbon, the first heating element being one of the plurality of heating elements; and a second heating operation supplying a second energy to a second heating element to heat the ink ribbon, the second energy being different from the first energy, the second heating element being one of the plurality of heating elements and different from the first heating element. The transfer member transfers both the first ink and the second ink onto the printing medium from the ink ribbon heated through the first heating operation. The transfer member transfers the second ink onto the printing medium from the ink ribbon heated through the second heating operation.

In the above configuration of the first aspect, by using the line thermal head to heat the ink ribbon, which includes the first ink layer and the second ink layer, the printing device can transfer both the first ink and second ink to the printing medium and transfer the second ink to the printing medium. Accordingly, the printing device can perform multicolor printing using one ink ribbon and one line thermal head, thereby simplifying the device configuration. Moreover, by using the line thermal head, the printing device can print a pattern using the first ink and a pattern using the second ink within a single line extending in the main scanning direction at a time. Accordingly, the printing device can achieve multicolor printing through a simplified configuration. Hence, it is possible to provide a printing device that is compact and easy to maintain.

The present disclosure also provides according to second aspect a printing method. The printing method includes: conveying an ink ribbon in a sub-scanning direction, the ink ribbon including a base layer, a first ink layer having a first ink, and a second ink layer having a second ink different from the first ink, wherein the base layer, the first ink layer, and the second ink layer are overlaid in this order; conveying, in the sub-scanning direction, a printing medium that is overlaid on the ink ribbon and faces the second ink layer; heating the ink ribbon with a plurality of heating elements in contact with the ink ribbon from the base layer side while the ink ribbon is conveyed in the conveying the ink ribbon, the plurality of heating elements being included in a line thermal head and being arranged in a main scanning direction orthogonal to the sub-scanning direction; transferring at least one of the first ink and the second ink from the ink ribbon heated by the line thermal head onto the printing medium by separating, from the printing medium, the ink ribbon that is conveyed to a position downstream of the line thermal head in the sub-scanning direction in the conveying the ink ribbon. The heating includes: supplying a first energy to a first heating element to heat the ink ribbon, the first heating element being one of the plurality of heating elements; and supplying a second energy to a second heating element to heat the ink ribbon, the second energy being different from the first energy, the second heating element being one of the plurality of heating elements and different from the first heating element. The transferring transfers both the first ink and the second ink onto the printing medium from the ink ribbon heated through the supplying the first energy. The transferring transfers the second ink onto the printing medium from the ink ribbon heated through the supplying the second energy. Thus, the configuration of the second aspect obtains the same effect as the first aspect.

### BRIEF DESCRIPTION OF DRAWINGS

FIG. 1 is a schematic diagram illustrating a printing device 1.

FIG. 2A-2C are explanatory diagrams illustrating a manner that a printing pattern is printed on a printing medium using a thermal head 5.

FIG. 3 is a cross section of an ink ribbon R.

FIG. 4A-4C are explanatory diagrams illustrating manners that a first ink 71 and a second ink 72 A are transferred to the printing medium M.

FIG. 5 is a table illustrating a relationship between a first energy E1 and a second energy E2.

FIG. 6 is a block diagram illustrating an electrical configuration of the printing device 1.

FIG. 7 is a flowchart illustrating the printing process.

### DESCRIPTION

A printing device 1 according to an embodiment of the present disclosure will be described while referring to the accompanied drawings. The accompanied drawings are just an example for illustrating technical features that may be employed in the present disclosure, but the present disclosure should not be limited only to the configuration illustrated in the drawings.

### Overview of a Printing Device 1

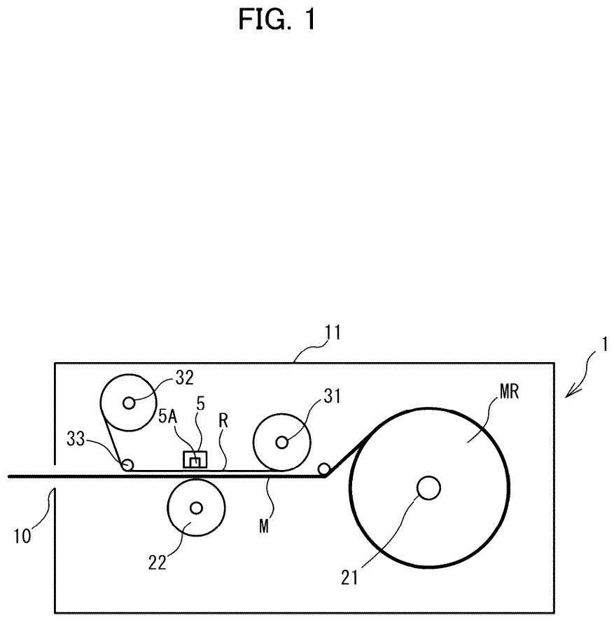

An overview of a printing device 1 will be described with reference to FIG. 1. The printing device 1 is a thermal transfer printer that prints by heating an ink ribbon R to transfer ink onto a printing medium M. A roll MR of wound printing medium M is removably accommodated in the printing device 1. The printing device 1 is provided with a roll support 21, a platen 22, a ribbon supply spool 31, a ribbon take-up spool 32, an ink ribbon peeling member 33, a thermal head 5, and the like.

The roll support 21 rotatably supports the core of the roll MR. The platen 22 rotates when driven by a motor 44 described later (see FIG. 6) while in contact with the printing medium M. As a result, the platen 22 draws the printing medium M off the roll MR and conveys the printing medium M toward a discharge unit 10 provided in a housing 11 of the printing device 1. The conveying direction of the printing medium M corresponds to a sub-scanning direction.

The ink ribbon R is wound around the ribbon supply spool 31. The ribbon take-up spool 32 draws unused ink ribbon R off the ribbon supply spool 31 and takes up ink ribbon R that has been used for printing. The ink ribbon R runs from the ribbon supply spool 31 along a conveying path. The conveying path along which the ink ribbon R is conveyed runs parallel to the conveying path of the printing medium M from the ribbon supply spool 31 so that the ink ribbon R is in contact with the surface of the printing medium M on the side opposite the platen 22 between the ribbon supply spool 31 and the ink ribbon peeling member 33, bends away from the printing medium M at the ink ribbon peeling member 33 so that the ink ribbon R is in contact with the ink ribbon peeling member 33, and extends to the ribbon take-up spool 32. The conveying direction of the ink ribbon R in the portion of the conveying path that runs parallel to the conveying path of the printing medium M is identical to the conveying direction of the printing medium M (i.e., the sub-scanning direction). Hereinafter, the conveying direction of the ink ribbon R in this portion of the conveying path that runs parallel to the printing medium M will be called the “conveying direction of the ink ribbon R.”

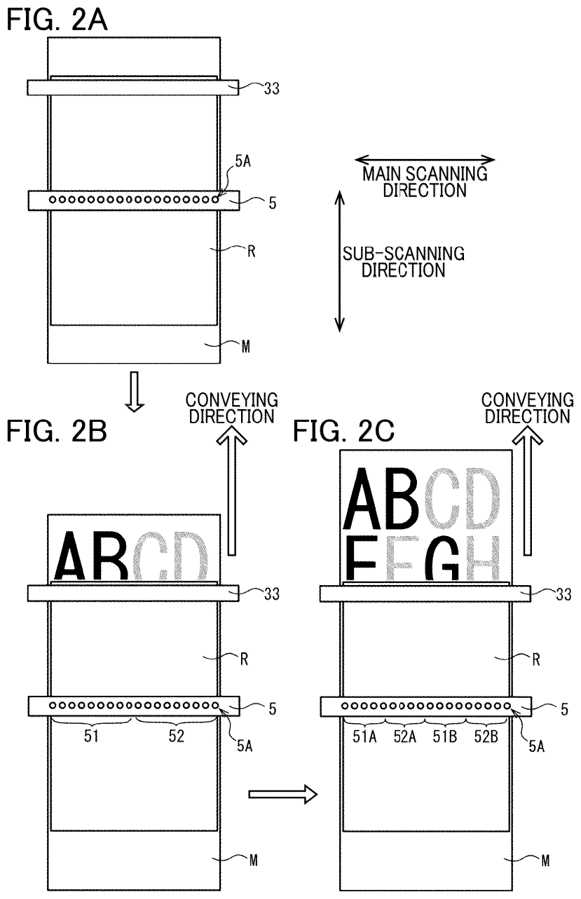

The thermal head 5 contacts the ink ribbon R drawn off the ribbon supply spool 31 on the opposite side surface of the ink ribbon R from the printing medium M. The ink ribbon R and printing medium M are interposed between the thermal head 5 and the platen 22. As illustrated in FIG. 2A, the thermal head 5 is a line thermal head. The thermal head 5 has a plurality of heating elements 5A aligned in a main scanning direction, which is orthogonal to the sub-scanning direction. The gap between the two heating elements 5A located on opposite ends of the plurality of heating elements 5A in the main scanning direction is approximately the same as the length of the printing medium M in the main scanning direction. The thermal head 5 heats the ink ribbon R by selectively heating the plurality of heating elements 5A in contact with the ink ribbon R.

The printing device 1 heats a plurality of the heating elements 5A in the thermal head 5 while conveying the printing medium M and ink ribbon R in the conveying direction. As a result, ink in the ink ribbon R melts and adheres to the printing medium M. After being heated by the thermal head 5, the ink ribbon R is peeled off the printing medium M at the ink ribbon peeling member 33 positioned downstream of the thermal head 5 in the conveying direction, as illustrated in FIGS. 2B and 2C. At this time, the ink adhered to the printing medium M is separated from the ink ribbon R and transferred to the printing medium M. Through this process, patterns are printed on the printing medium M.

### Ink Ribbon R

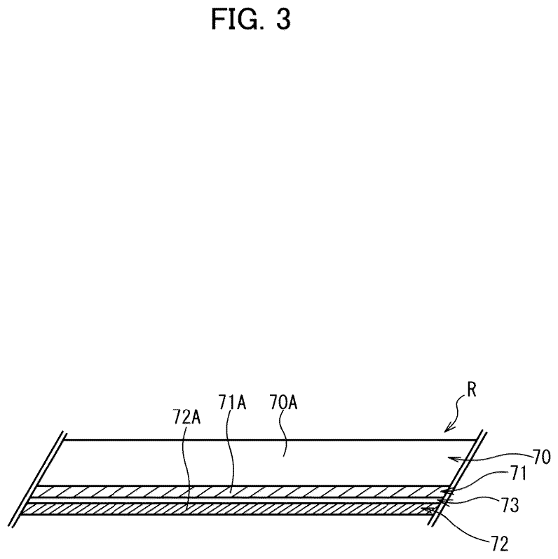

The ink ribbon R will be described with reference to FIG. 3. The ink ribbon R has a base layer 70, a first ink layer 71, an intermediate layer 73, and a second ink layer 72. The base layer 70, first ink layer 71, intermediate layer 73, and second ink layer 72 are overlaid in this order.

The base layer 70 contains a base material 70A made of PET. The first ink layer 71 contains a first ink 71A. The second ink layer 72 contains a second ink 72A that is different from the first ink 71A. The intermediate layer 73 is interposed between the first ink layer 71 and second ink layer 72.

### Overview of the Printing Method

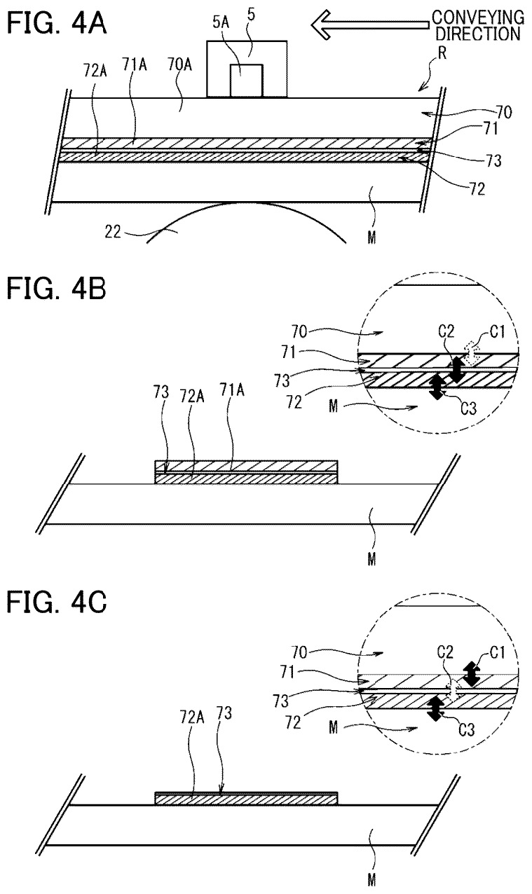

In the printing process performed by the printing device 1, the printing medium M is overlaid on the ink ribbon R and faces the second ink layer 72, as illustrated in FIG. 4A. Further, the plurality of heating elements 5A in the thermal head 5 are arranged at positions where the plurality of heating elements 5A faces the base layer 70 of the ink ribbon R and is in contact with the base layer 70. By selectively controlling the energy supplied to the plurality of heating elements 5A in the thermal head 5, the printing device 1 changes whether both the first ink 71A of the first ink layer 71 and the second ink 72A of the second ink layer 72 are transferred onto the printing medium M from the ink ribbon R (see FIG. 4B) or the second ink 72A of the second ink layer 72 is transferred onto the printing medium M from the ink ribbon R (see FIG. 4C).

For example, the printing device 1 heats the ink ribbon R by supplying a first energy E1 to some of the plurality of heating elements 5A in the thermal head 5 (hereinafter called the “first heating elements”). In this case, a bond strength C1 between the base layer 70 and first ink layer 71 becomes lower than a bond strength C2 between the first ink layer 71 and second ink layer 72 and a bond strength C3 between the second ink layer 72 and printing medium M, as illustrated in FIG. 4B.

When the ink ribbon peeling member 33 peels the ink ribbon R off the printing medium M, the ink ribbon R breaks apart between the base layer 70 and first ink layer 71 where the bond strength is relatively low. As a result, the first ink 71A of the first ink layer 71, the intermediate layer 73, and the second ink 72A of the second ink layer 72 are transferred to the printing medium M from the ink ribbon R, which has been heated by the first heating elements. In this case, the first ink 71A is exposed, producing a printing pattern on the printing medium M in the color of the first ink 71A.

As another example, the printing device 1 heats the ink ribbon R by supplying a second energy E2 different from the first energy E1 to some of the plurality of heating elements 5A in the thermal head 5 different from the first heating elements (hereinafter called the “second heating elements”). In this case, the bond strength C2 between the first ink layer 71 and second ink layer 72 becomes lower than the bond strength C1 between the base layer 70 and first ink layer 71 and the bond strength C3 between the second ink layer 72 and printing medium M, as illustrated in FIG. 4C.

As the ink ribbon peeling member 33 peels the ink ribbon R off the printing medium M, the ink ribbon R breaks apart at the intermediate layer 73, i.e., between the first ink layer 71 and second ink layer 72 where the bond strength is relatively low. As a result, a portion of the intermediate layer 73 and the second ink 72A of the second ink layer 72 are transferred to the printing medium M from the ink ribbon R, which has been heated by the second heating elements. In this case, the second ink 72A is exposed through the intermediate layer 73, producing a printed pattern on the printing medium M in the color of the second ink 72A.

For example, the printing device 1 supplies the first energy E1 to first heating elements 51 and supplies the second energy E2 to second heating elements 52 among the plurality of heating elements 5A in the thermal head 5, as shown in FIG. 2B. Through this process, the “AB” portion of the printing pattern “ABCD” aligned in the main scanning direction appears in the color of the first ink 71A while the “CD” portion appears in the color of the second ink 72A. As another example, the printing device 1 supplies the first energy E1 to first heating elements 51A and 51B and supplies the second energy E2 to second heating elements 52A and 52B among the plurality of heating elements 5A in the thermal head 5, as illustrated in FIG. 2C. Through this process, the “E” and “G” portions of the printing pattern “EFGH” aligned in the main scanning direction appear in the color of the first ink 71A, while the “F” and “H” portions appear in the color of the second ink 72A. By controlling the energy supplied to each of the plurality of heating elements 5A in this way, the printing device 1 can quickly print a printing pattern using inks of different types along the main scanning direction.

### Supply Conditions

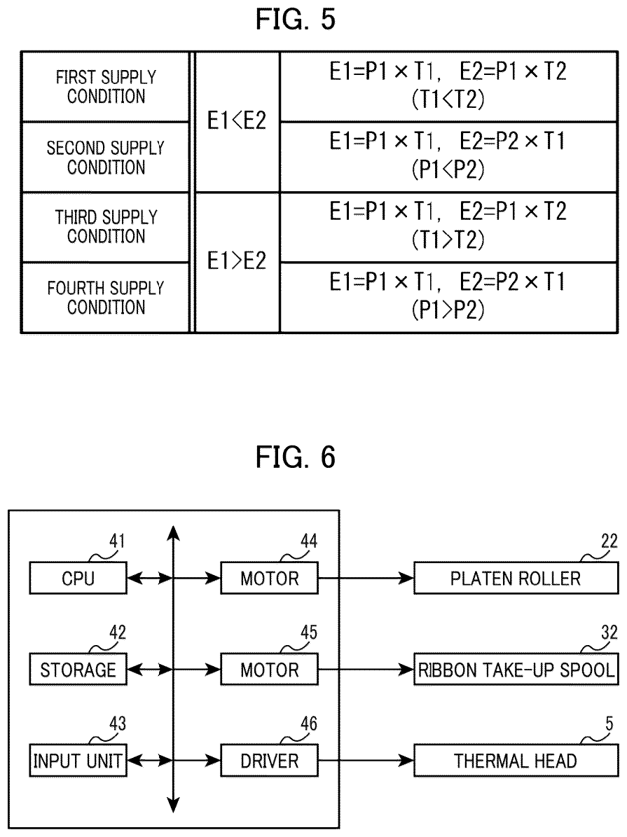

The printing device 1 changes the respective supply conditions for the first energy E1 supplied to the first heating elements of the thermal head 5 and the second energy E2 supplied to the second heating elements according to the type of ink ribbon R being used. Below, first through fourth supply conditions will be described with reference to FIG. 5.

Under the first supply condition, the second energy E2 is greater than the first energy E1 (E1<E2). Further, the printing device 1 supplies the first energy E1 to each of the first heating elements by supplying a first power P1 for a first time T1. The first energy E1, first power P1, and first time T1 satisfy the relationship “E1=P1×T1”. On the other hand, the printing device 1 supplies the second energy E2 to each of the second heating elements by supplying the first power P1 for a second time T2 longer than the first time T1 (T1<T2). The second energy E2, first power P1, and second time T2 satisfy the relationship “E2=P1×T2”.

Under the second supply condition, the second energy E2 is greater than the first energy E1 (E1<E2), as with the first supply condition. Further, the printing device 1 supplies the first energy E1 to each of the first heating elements by supplying a first power P1 for a first time T1. On the other hand, the printing device 1 supplies the second energy E2 to each of the second heating elements by supplying a second power P2 greater than the first power P1 (P1<P2) for the first time T1. The second energy E2, second power P2, and first time T1 satisfy the relationship “E2=P2×T1”.

Under the third supply conditions, the second energy E2 is smaller than the first energy E1 (E1>E2). Further, the printing device 1 supplies the first energy E1 to each of the first heating elements by supplying a first power P1 for a first time T1. On the other hand, the printing device 1 supplies the second energy E2 to each of the second heating elements by supplying the first power P1 for a second time T2 shorter than the first time T1 (T1>T2).

Under the fourth supply condition, the second energy E2 is smaller than the first energy E1 (E1>E2), as with the third supply condition. Further, the printing device 1 supplies the first energy E1 to each of the first heating elements by supplying a first power P1 for a first time T1. On the other hand, the printing device 1 supplies the second energy E2 to each of the second heating elements by supplying a second power P2 smaller than the first power P1 (P1>P2) for the first time T1.

### Electrical Configuration of the Printing Device 1

As shown in FIG. 6, the printing device 1 has a CPU 41, a storage 42, an input unit 43, motors 44 and 45, and a driver 46.

The CPU 41 manages overall control of the printing device 1. The storage 42 stores programs to be executed by the CPU 41, print data, and the like. The input unit 43 includes switches for configuring various settings on the printing device 1. The motor 44 is driven to rotate the platen 22, whereby the platen 22 conveys the printing medium M in the conveying direction. The motor 45 is driven to rotate the ribbon take-up spool 32 so that the ribbon take-up spool 32 conveys the portion of the ink ribbon R that is in contact with the printing medium M, i.e., the portion of the ink ribbon R between the ribbon supply spool 31 and the ink ribbon peeling member 33, in the conveying direction. The driver 46 drives the thermal head 5 to selectively heat each of the plurality of heating elements 5A.

### Printing Process

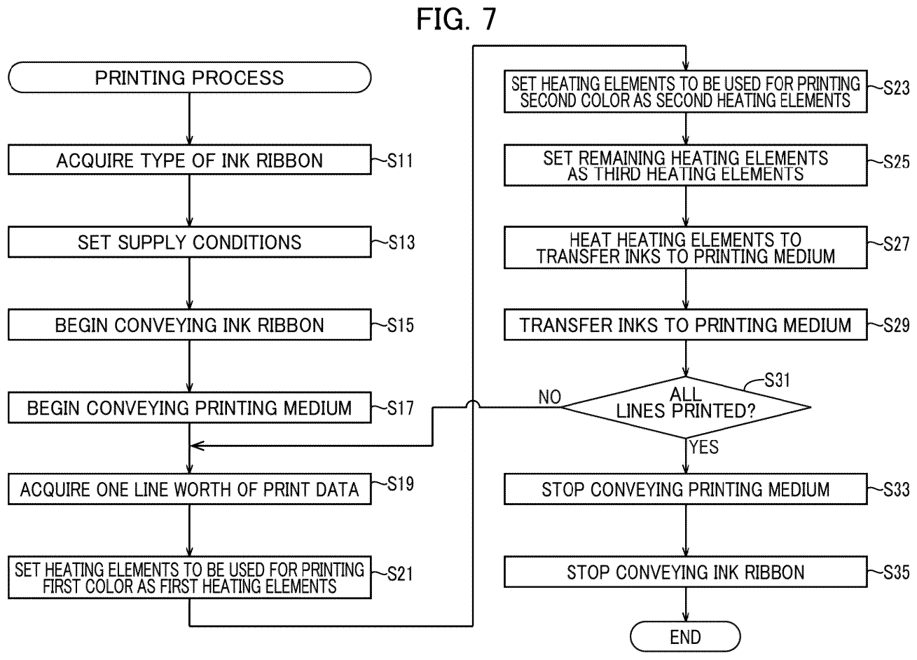

A printing process will be described with reference to FIG. 7. When the input unit 43 detects an instruction to begin printing a pattern, the CPU 41 starts the printing process by reading and executing a program stored in the storage 42.

First, in S11 the CPU 41 acquires the type of ink ribbon R to be used. Based on the acquired type of ink ribbon R, in S13 the CPU 41 sets one of the first through fourth supply conditions (see FIG. 5) as the condition for supplying energy to each of the plurality of heating elements 5A in the thermal head 5.

In S15 the CPU 41 begins conveying the ink ribbon R by driving the motor 45 to rotate the ribbon take-up spool 32. Next, in S17 the CPU 41 begins conveying the printing medium M by driving the motor 44 to rotate the platen 22.

In S19 the CPU 41 acquires, from the storage 42, one line worth of print data that can be printed at one time by heat generated from the plurality of heating elements 5A of the thermal head 5. In S21 the CPU 41 selects the heating elements to be used for printing the printing pattern in the color of the first ink 71A from among the plurality of heating elements 5A based on the acquired line worth of print data. Subsequently, in S21 the CPU 41 sets the selected heating elements as the first heating elements. In S23 the CPU 41 also selects heating elements to be used for printing the printing pattern in the color of the second ink 72A from among the plurality of heating elements 5A based on the acquired line worth of print data. Subsequently, in S23 the CPU 41 sets the selected heating elements as the second heating elements. In S25 the CPU 41 sets those heating elements 5A that have not been set as either the first heating elements or the second heating elements as third heating elements, which are not to generate heat.

In S27, based on the supply conditions set in the process of S13, the CPU 41 determines conditions for the power P and time T when supplying one of the first energy E1 and second energy E2 to each of the plurality of heating elements 5A. Subsequently, in S27 the CPU 41 supplies the first energy E1 to the first heating elements set in S21 and supplies the second energy E2 to the second heating elements set in S23.

In S29 the CPU 41 then continues to convey the ink ribbon R with the ribbon take-up spool 32 and to convey the printing medium M with the platen 22. As a result, the portion of the ink ribbon R heated by the heating elements 5A of the thermal head 5 is peeled off the printing medium M by the ink ribbon peeling member 33. At this time, in S29 both the first ink 71A and second ink 72A are transferred to the printing medium M from the areas of the ink ribbon R heated by the first heating elements while only the second ink 72A is transferred to the printing medium M from areas of the ink ribbon R heated by the second heating elements.

In S31 the CPU 41 determines whether all lines in the printing pattern have been printed. In a case where there remain unprinted lines among the lines configuring the printing pattern (S31: NO), the CPU 41 returns to S19. In S19 the CPU 41 acquires one line worth of print data for one of the unprinted lines from the storage 42 and repeats the above process in S21-S29. However, in a case where the CPU 41 determines that all lines of the printing pattern have been printed (S31: YES), the CPU 41 advances to S33.

In S33 the CPU 41 stops conveying the printing medium M by terminating the drive of the motor 44 to halt the rotation of the platen 22. In S35 the CPU 41 stops conveying the ink ribbon R by terminating the drive of the motor 45 to halt the rotation of the ribbon take-up spool 32. The CPU 41 then ends the printing process.

### Operations and Effects of the Embodiment

By using the thermal head 5 to heat the ink ribbon R, which includes the first ink layer 71 and the second ink layer 72, the printing device 1 can transfer both the first ink 71A and second ink 72A to the printing medium M and transfer the second ink 72A to the printing medium M. Accordingly, the printing device 1 can perform multicolor printing using one ink ribbon R and one thermal head 5, thereby simplifying the device configuration. Moreover, by using a line thermal head as the thermal head 5, the printing device 1 can print one line extending in the main scanning direction at a time. Accordingly, the printing device 1 can print a pattern using the first ink and a pattern using the second ink within a single line. Hence, the printing device 1 can achieve multicolor printing through a simplified configuration, making it possible to provide a printing device 1 that is compact and easy to maintain.

Under the first and second supply conditions, the second energy E2 required for transferring the second ink 72A to the printing medium M is higher than the first energy E1 required for transferring the first ink 71A and second ink 72A to the printing medium M (E1<E2). Thus, the printing device 1 can perform multicolor printing by supplying energy to the plurality of heating elements 5A in the thermal head 5 under these supply conditions.

Under the first supply condition, the printing device 1 supplies the first energy E1 to the first heating elements by supplying a first power P1 for a first time T1 and supplies the second energy E2 to second heating elements by supplying the first power P1 for a second time T2, which is longer than the first time T1 (T1<T2). In this case, the printing device 1 can produce the second energy E2 that is higher than the first energy E1 without modifying the power supplied to the plurality of heating elements 5A.

Under the second supply conditions, the printing device 1 supplies the first energy E1 to the first heating elements by supplying a first power P1 for a first time T1 and supplies the second energy E2 to the second heating elements by supplying a second power P2, which is greater than the first power P1 (P1<P2), for the first time T1. In this case, the printing device 1 can produce a second energy E2 that is higher than the first energy E1 without modifying the time for which power is supplied to the plurality of heating elements 5A.

Under the third and fourth supply conditions, the second energy E2 required for transferring the second ink 72A to the printing medium M is lower than the first energy E1 required for transferring both the first ink 71A and second ink 72A to the printing medium M (E1>E2). Thus, the printing device 1 can perform multicolor printing by supplying energy to the plurality of heating elements 5A in the thermal head 5 under these supply conditions.

Under the third supply conditions, the printing device 1 supplies the first energy E1 to the first heating elements by supplying a first power P1 for a first time T1 and supplies the second energy E2 to the second heating elements by supplying the first power P1 for a second time T2, which is shorter than the first time T1 (T1>T2). In this case, the printing device 1 can produce the second energy E2 that is lower than the first energy E1 without modifying the power supplied to the plurality of heating elements 5A.

Under the fourth supply conditions, the printing device 1 supplies the first energy E1 to the first heating elements by supplying a first power P1 for a first time T1 and supplies the second energy E2 to the second heating elements by supplying a second power P2, which is smaller than the first power P1 (P1>P2), for the first time T1. In this case, the printing device 1 can produce a second energy E2 that is lower than the first energy E1 without modifying the time for which power is supplied to the plurality of heating elements 5A.

By supplying the first energy E1 to the first heating elements, the printing device 1 can make the bond strength C1 between the base layer 70 and first ink layer 71 the weakest so that the ink ribbon R breaks apart between the base layer 70 and the first ink layer 71, allowing the first ink 71A and second ink 72A to be transferred onto the printing medium M. Further, by supplying the second energy E2 to the second heating elements, the printing device 1 can make the bond strength C2 between the first ink layer 71 and second ink layer 72 the weakest so that the intermediate layer 73 therebetween breaks apart, enabling the second ink layer 72 to be transferred onto the printing medium M alone.

### Variations

The present disclosure may be modified in various ways and is not limited to the embodiment described above. A cartridge accommodating the ink ribbon R and printing medium M may be detachably mounted in the printing device 1. The ink ribbon R and printing medium M may be conveyed by a common conveying mechanism. The printing device 1 may move the thermal head 5 in the sub-scanning direction relative to the printing medium M and ink ribbon R. The user may set the energy supply condition through the input unit 43. Alternatively, the printing device 1 may select one of the first through fourth supply conditions according to the ambient temperature, type of printing medium M, and the like.

The ink ribbon R need not possess the intermediate layer 73. In this case, the first ink layer 71 and second ink layer 72 may be in contact with each other. A welding layer including a welding material may be interposed between the base layer 70 and the first ink layer 71. The bond strength between the base layer 70 and the first ink layer 71 may be adjusted by the welding layer. A backing layer may be provided on the opposite side surface of the base layer 70 from the first ink layer 71. Further, an adhesive layer may be provided on the second ink layer 72 on at least one of the first ink layer 71 side and the opposite side.

Energy may be supplied to the plurality of heating elements 5A by continuously supplying a prescribed power P (the first power P1 or second power P2) for the prescribed time T (the first time T1 or second time T2) or may be supplied according to a different method. For example, the prescribed power P may be supplied intermittently to the plurality of heating elements 5A. In this case, the prescribed time T is the total supply time of the intermittent power supply. The period for these intermittent supply of power P may be constant or not constant.

Each of the plurality of heating elements 5A may be configured with variable resistance. The printing device 1 may adjust the power supplied to the plurality of heating elements 5A by individually adjusting the resistance value of each of the plurality of heating elements 5A.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

### Additional Information

The ribbon take-up spool 32 is an example of the first conveying member of the present disclosure. The platen 22 is an example of the second conveying member of the present disclosure. The thermal head 5 is an example of the line thermal head of the present disclosure. The ink ribbon peeling member 33 is an example of the transfer member of the present disclosure. The CPU 41 is an example of the processor of the present disclosure. The CPU 41 performing the process of S27 is an example of the processor performing the first heating operation of the present disclosure and an example of the processor performing the second heating operation of the present disclosure. The process of S15 is an example the first conveying step of the present disclosure. The process of S17 is an example of the second conveying step of the present disclosure. The process of S27 is an example of the heating step, the first heating step, the second heating step of the present disclosure. The process of S29 is an example of the transferring step of the present disclosure.

What is claimed is:

1. A printing device comprising:
a first conveying member configured to convey an ink ribbon in a sub-scanning direction, the ink ribbon including a base layer, a first ink layer having a first ink, and a second ink layer having a second ink different from the first ink, wherein the base layer, the first ink layer, and the second ink layer are overlaid in this order;
a second conveying member configured to convey, in the sub-scanning direction, a printing medium that is overlaid on the ink ribbon and faces the second ink layer;
a line thermal head having a plurality of heating elements arranged in a main scanning direction orthogonal to the sub-scanning direction, wherein the plurality of heating elements is configured to be in contact with the ink ribbon from the base layer side to heat the ink ribbon while the ink ribbon is conveyed by the first conveying member;
a transfer member positioned downstream of the line thermal head in the sub-scanning direction, the transfer member being configured to transfer at least one of the first ink and the second ink from the ink ribbon heated by the line thermal head onto the printing medium, by separating the ink ribbon conveyed by the first conveying member from the printing medium; and
a processor configured to control the first conveying member, the second conveying member, the line thermal head, and the transfer member,
wherein the processor is configured to perform:
a first heating operation supplying a first energy to a first heating element to heat the ink ribbon, the first heating element being one of the plurality of heating elements; and
a second heating operation supplying a second energy to a second heating element to heat the ink ribbon, the second energy being different from the first energy, the second heating element being one of the plurality of heating elements and different from the first heating element,
wherein the transfer member transfers both the first ink and the second ink onto the printing medium from the ink ribbon heated through the first heating operation,
wherein the transfer member transfers the second ink onto the printing medium from the ink ribbon heated through the second heating operation.

2. The printing device according to claim 1, wherein the second energy is greater than the first energy.

3. The printing device according to claim 2, wherein the first heating operation supplies the first energy to the first heating element by supplying a first power for a first time,
wherein the second heating operation supplies the second energy to the second heating element by supplying the first power for a second time longer than the first time.

4. The printing device according to claim 2, wherein the first heating operation supplies the first energy to the first heating element by supplying a first power for a first time,
wherein the second heating operation supplies the second energy to the second heating element by supplying a second power for the first time, the second power being greater than the first power.

5. The printing device according to claim 1, wherein the second energy is smaller than the first energy.

6. The printing device according to claim 5, wherein the first heating operation supplies the first energy to the first heating element by supplying a first power for a first time,
wherein the second heating operation supplies the second energy to the second heating element by supplying the first power for a second time shorter than the first time.

7. The printing device according to claim 5, wherein the first heating operation supplies the first energy to the first heating element by supplying a first power for a first time,
wherein the second heating operation supplies the second energy to the second heating element by supplying a second power for the first time, the second power being smaller than the first power.

8. The printing device according to claim 1, wherein in a case where the first heating operation heats the ink ribbon, a bond strength between the base layer and the first ink layer becomes smaller than both a bond strength between the first ink layer and the second ink layer and a bond strength between the second ink layer and the printing medium,
wherein in a case where the second heating operation heats the ink ribbon, the bond strength between the first ink layer and the second ink layer becomes smaller than both the bond strength between the base layer and the first ink layer and the bond strength between the second ink layer and the printing medium.

9. A printing method comprising:
conveying an ink ribbon in a sub-scanning direction, the ink ribbon including a base layer, a first ink layer having a first ink, and a second ink layer having a second ink different from the first ink, wherein the base layer, the first ink layer, and the second ink layer are overlaid in this order;
conveying, in the sub-scanning direction, a printing medium that is overlaid on the ink ribbon and faces the second ink layer;
heating the ink ribbon with a plurality of heating elements in contact with the ink ribbon from the base layer side while the ink ribbon is conveyed in the conveying the ink ribbon, the plurality of heating elements being included in a line thermal head and being arranged in a main scanning direction orthogonal to the sub-scanning direction; and
transferring at least one of the first ink and the second ink from the ink ribbon heated by the line thermal head onto the printing medium by separating, from the printing medium, the ink ribbon that is conveyed to a position downstream of the line thermal head in the sub-scanning direction in the conveying the ink ribbon,
wherein the heating includes:
supplying a first energy to a first heating element to heat the ink ribbon, the first heating element being one of the plurality of heating elements; and
supplying a second energy to a second heating element to heat the ink ribbon, the second energy being different from the first energy, the second heating element being one of the plurality of heating elements and different from the first heating element,
wherein the transferring transfers both the first ink and the second ink onto the printing medium from the ink ribbon heated through the supplying the first energy,
wherein the transferring transfers the second ink onto the printing medium from the ink ribbon heated through the supplying the second energy.
